(19) United States
(12) Patent Application Publication
(10) Pub. No.: US 2025/0359571 A1
(43) Pub. Date: Nov. 27, 2025

(54) INSTANT FOOD POWDER COMPRISING PEA AND OAT PROTEINS AND NO DAIRY PROTEIN

(71) Applicant: SOCIETE DES PRODUITS NESTLE S.A., Vevey (CH)

(72) Inventors: DIAMANTO ANGELOPOULOU, Aarau (CH); BRUNO EDGAR CHAVEZ MONTES, Lausanne (CH); VERONICA CALDEO, Bern (CH)

(21) Appl. No.: 18/864,278

(22) PCT Filed: May 10, 2023
(86) PCT No.: PCT/EP2023/062332

§ 371 Date: Nov. 8, 2024

(30) Foreign Application Priority Data
May 10, 2022 (EP) 22172656.5

(51) Int. Cl. A23L 2/66; A23C 11/10; A23L 2/39; A23L 11/60; A23L 33/185; A23L 33/21

(52) U.S. Cl. CPC A23L 2/66; A23C 11/103; A23L 2/39; A23L 11/60; A23L 33/185; A23L 33/21

(57) ABSTRACT

The present invention relates to a spray dried beverage or food powder comprising 10-35 wt. % pea protein, 2-15 wt. % other plant protein, 3-8 wt. %, preferably 4-5 wt. % fibers, selected from the group consisting of cereal, pseudo cereals seeds or a combination thereof, 0-30 wt. %, preferably 12 to 18 wt. % vegetable oil or fat, optionally a source of fortification, and optionally stabilizing salts, and wherein the total protein content is 12 to 40 wt. %. The invention also relates to a method for making the beverage or food powder.

### CROSS REFERENCE TO RELATED APPLICATIONS

The present application is a National Stage of International Application No. PCT/EP2023/062332, filed on May 10, 2023, which claims priority to European Patent Application No. 22172656.5, filed on May 10, 2022, the entire contents of which are being incorporated herein by reference.

### FIELD OF THE INVENTION

The present invention relates to instant beverage or food powder. In particular, the present invention relates to a beverage or food powder with a high plant-protein content with good reconstitution properties. The food or dairy product may be devoid of dairy products.

Dairy alternatives usually do not comprise dairy proteins but comprise alternative protein sources.

### BACKGROUND

Certain consumers wish to consume less milk or do not want to consume milk at all, for example, because of its animal origin, due to lactose intolerance or due to dairy allergies. They may also see potential environmental sustainability issues.

As a consequence, consumers seek alternatives to milk. Alternatives to milk do exist and the dairy alternatives market is growing by 11% each year and finding an alternative with good nutrition and taste will be a major advantage in this competitive field.

WO 2013078510 discloses a nut-based milk analogue composition that has a substantially similar nutritional profile as cow milk.

CA2982280 discloses a method of producing a milk alternative, without necessarily adding a gum or emulsifier or starch, using chickpeas and/or other whole legumes or lentils (regular, sprouted or fermented), using pea protein, chickpea protein and/or a combination of plant-based protein (regular, sprouted or fermented), using flax seed oil and/or other vegetable oil, through high rotation mixing, heat and pressure, producing a very smooth mouthfeel.

Pea protein containing milk alternatives are commercially available. However, consumers increasingly search for food compositions that can be used as dairy alternatives that have an excellent nutritional value and a pleasant taste profile. In particular, there is a need for such food compositions that are high in protein and fibers.

Prior art plant-based powders are either low in protein content or, when protein content is higher, are in a dry-mix format which is not easy to reconstitute.

In particular, the inclusion of fiber while maintaining a pleasant taste and texture profile appears to be difficult. In accordance with this US20130196028A1 discloses a method of making a chickpea soluble fraction, but which includes the removal of dietary fiber by filtration.

Also, if milk protein is replaced by plant protein sources, this often results in an unpleasant taste, and the composition can be perceived as bitter and/or astringent.

It would therefore be desirable to provide a powder beverage that can be used as milk alternative, contains fiber and that has a good nutritional profile and taste profile.

Any reference to prior art documents in this specification is not to be considered an admission that such prior art is widely known or forms part of the common general knowledge in the field.

### OBJECT OF THE INVENTION

The objective of the present invention is to improve the state of the art and in particular to provide a beverage or food powder that can be used in the preparation of dairy alternative and that is high in protein and fiber and that provides a good nutritional profile, and a good taste profile. More particularly, the objective of the invention is to provide a high protein powder that can be dissolved without sediment, with improved stability in hard water, and that has a good dissolution time both in hot and ambient water.

### SUMMARY OF THE INVENTION

The present invention provides the improvement by the subject matter of the independent claims. The dependent claims further develop the idea of the present invention.

In a first aspect, the invention relates to a spray dried beverage or food powder comprising
10-35 wt. % pea protein,
2-15 wt. % other plant protein,
3-8 wt. %, preferably 4-5 wt. % fibers, selected from the group consisting of cereal, pseudo cereals seeds or a combination thereof,
0-30 wt. %, preferably 12 to 18 wt. % vegetable oil or fat,
optionally a source of fortification, and
optionally stabilizing salts, and
wherein the total protein content is 12 to 40 wt. %,

High protein content in powders is desirable when the nutritional target in final reconstituted powder is about 2 grams of protein or higher in 100 ml reconstituted beverage. While spraying of low protein systems is relatively easy, spray drying high protein powder (e.g. above 20 wt. %) presents problem due to blocking or pumping issues. On the other hand, it has been found that dry mixed or steam agglomerated plant-based powders have poor reconstitution in ambient or cold liquid. Stability of beverage or food powders are required if the powder is to be reconstituted in acid liquid such as coffee. This means that no flocculation of the protein in the final beverage or food product should take place. Finally, high caloric or non-clean label product is for many purposes not desirable.

The present invention provides an improved beverage or food powder that provides solution to technical challenges:
dispersion of high protein content product with low viscosity to allow spray drying
a drying process that is delivering instant reconstitution performance in the powder
formulation delivering high nutrition, good taste and texture of a reconstituted beverage
composition offering the versatility of milk for preparing a drink alone or combination with coffee, also as topping or cooking aid (e.g. for pancakes etc).

It has been found that the present invention may provide high protein content in powder >15 wt. %, high fibre content in powder >20 wt. %, instant properties in ambient or hot water, and stability in hard water.

It has further been found that a total protein content below 12 wt. % provides too little protein/nutritional value in the final reconstituted product, while above 40 wt. % protein in the powder, while total solids in the plant protein mix above 48 wt. % does not allow spray drying.

In a second aspect, the invention relates to a method of making a beverage powder comprising the steps of
providing a plant protein mixture of pea protein, other plant protein, enzyme, and cereals or pseudo cereals with 30-40% total solids and preferably having a pH of between 6 and 9,
hydrolysing the mixture for 10 min to 1 hour,
optionally dispersing vegetable oil or fat in the mixture, preferably to a 40-48% total solids,
heat treating and homogenizing the mixture and
spray drying the mixture to obtain a beverage powder.

Examples of cereals are oat, rice, wheat, barley, corn, millet, or a combination thereof. Examples of pseudo cereals are quinoa, buckwheat, amaranth or a combination thereof.

In another aspect, the invention relates to a method of making a beverage or food powder comprising the steps of
adding enzyme in water,
adding cereals and/or pseudo cereals at a 15-30% total solids,
hydrolyzing the cereals and/or pseudo cereals for 10 min to 1 hour
adding the pea protein and other plant protein to a 30-40% total solids to water to form a plant protein mixture and preferably having a pH of between 6 and 9,
optionally dispersing vegetable oil or fat in the plant protein mixture, preferably to 40-48% total solids,
heat treating and homogenizing the plant protein mixture and
spray drying the mixture to obtain a beverage powder.

As used in this specification, the words “comprises”, “comprising”, and similar words, are not to be interpreted in an exclusive or exhaustive sense. In other words, they are intended to mean “including, but not limited to”.

In the present context the other plant protein may be from oat, rice, quinoa, millet, wheat, or amaranth. Alternatively, the other plant protein may be from faba bean, chickpea, lentils, kidney beans, navy beans, pinto beans, haricot beans, lima beans, butter beans, azuki beans, mung beans, golden gram, green gram, black gram, urad, scarlet runner beans, rice beans, garbanzo beans, cranberry beans, lima beans, green peas, snow peas, snap peas, split peas and black-eyed peas.

In the present content the cereals or pseudo cereals may e.g. be oat, rice, quinoa, buckwheat, and amaranth.

Further, in the present context enzymes used may be α-amylase, α-amylase with side β-glucanase activity, and amyloglucosidase.

It has been found that the composition of the present invention achieves the objective of the present invention.

The beverage powder of the present invention was found to have instant properties, smooth texture, good taste, physical stability after reconstitution and with high protein content. A beverage made based on the beverage powder according to the invention was further found to be surprisingly stable in hard water.

Furthermore, it has been found that a wet mix can be prepared based on the beverage composition at a concentration that allows a cost-effective spray-drying with a viscosity within the operational limits.

The total solids of the plant based mix should preferably be >35% while the viscosity should remain within limits throughout the plant based mixture preparation steps (mixing, homogenization, heat treatment). This will allow the mixture to be pumped and sprayed properly in a drying tower.

### BRIEF DESCRIPTION OF THE DRAWINGS

FIG. 1 illustrates schematically an embodiment of the method for making a beverage or food powder according to the invention.

FIG. 2 shows a beverage powder according to the invention and a reconstituted beverage.

FIG. 3 is a chart showing hard water stability of the reconstituted beverage.

FIG. 4 is a chart showing instant reconstitution properties of the beverage or food powder according to the invention.

FIGS. 5a and 5b show the plant-based mixture before spray drying with and without starch-degrading enzymatic treatment of the plant-based mixture.

FIG. 6a shows a stable product obtained with the beverage or food powder according to the invention. FIGS. 6b and 6c shows products not according to the claimed invention and which have flocculation/phase separation.

### DETAILED DESCRIPTION OF THE INVENTION

Consequently, the present invention relates to a spray dried beverage or food powder comprising 10-35 wt. % pea protein, 2-12 wt. % other plant protein, 3-8 wt. %, preferably 4-5 wt. % fibers, selected from the group consisting of cereal, pseudo cereals seeds or a combination thereof, 0-30 wt. %, preferably 12 to 18 wt. % vegetable oil or fat, optionally a source of fortification, and optionally stabilizing salts, and wherein the total protein content is 12 to 40 wt. %.

The present invention provides a high protein plant-based beverage or food powder that is sprayed dried and which has excellent reconstitution properties even with the high protein content. Furthermore, the powder is stable both in acid liquid such as coffee with no flocculation of the proteins in the beverage and no sedimentation the first 20 min after preparation of the beverage or food product. The powder according to the invention has the additional benefit of providing a fiber content e.g, above 1.25 g per serving of 25 g, and may be formulated as a clean-label product.

In a preferred embodiment of the invention, oil is added to the recipe and a creamy smooth mouthfeel can be obtained in sprayed dried powder. It has been found that oil contributes to bulking and mouthfeel because small droplets of oil are present in the reconstituted product, while adding e.g. more than 5 wt. % oil to dry mixed powder glue the powders together and provide poor reconstitution properties.

High protein quality is desirable for beverage and food products. The protein quality is indicated with its PDCAAS. Plant-based powder are often poor in protein quality. The present invention provides a powder that has a high PDCAAS due to the combination of plant proteins' intrinsic amino-acid profiles complement one another. A beverage or food product according to the present invention comprising pea, oat and rice protein thus has a PDCAAS equal to 1.0 while a powder with pea protein only has a PDCAAS of 0.85.

The method according to the invention provides the additional benefit that high protein and high fiber ingredient mixes can be spray dried. It has been found that by combining pulse proteins, preferably pea, with cereal protein, and enzymatically treating the mixture to break down starch and optionally fibers with appropriate enzymes, the obtained reduced viscosity is sufficient to allow the mixture to be spray dried. Without the enzymatic treatment spray drying has been found to be difficult due to pumping or spraying.

In a preferred embodiment of the method according to the invention the protein is not hydrolyzed as this may provide an off taste.

The powder and method according to the invention may provide the additional benefit of a long shelf-life (physically stable) due to low amounts of mono and di-saccharides, high physical stability (high Tg=glass transition temperature). This has been found to be possible when cereal flour is the main source of carbohydrates, and the product is low in mono and di-saccharides as the enzymatic hydrolysis of the starch does not generate high amounts of mono and di-saccharides while, when high amount of di-saccharides is sugar added to the product, the powder would have lower Tg (lower physical stability).

The reconstituted product has a good taste due to the combination of the plant proteins and the cereals. For example, beany flavor may be masked by other plant notes.

The liquid food composition prepared with a powder according to the present invention does not comprise dairy protein or hydrocolloid, e.g. as gellan gum.

The term “food” shall be understood in accordance with Codex Alimentarius as any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

For the purpose of the present invention, a food may be considered high in protein, if at least 20% of the energy value of the food is provided by protein.

For the purpose of the present invention, a food may be considered high in calcium, if the product contains at least twice the value of ‘source of calcium’. A food may be considered a ‘source of calcium’ if the product contains at least a significant amount as defined in the Annex to Directive 90/496/EEC or an amount provided for by derogations granted according to Article 6 of Regulation (EC) No 1925/2006 of the European Parliament and of the Council of 20 Dec. 2006 on the addition of vitamins and minerals and of certain other substances to foods. 15% of the recommended allowance supplied by 100 g or 100 ml or per package if the package contains only a single portion should be taken into consideration in deciding what constitutes a significant amount.

Pea protein isolate is commercially available from many sources, for example from suppliers such as Cosucra or Roquette.

Dairy proteins are milk proteins synthesized in the mammary gland and comprise caseins and whey proteins. For example, dairy proteins may comprise caseins, β-lactoglobulin, α-lactalbumin, blood serum albumin, immunoglobulins, lactoferrin, and transferrin.

In a preferred embodiment of the beverage or food powder of the invention, the other plant protein is selected from the group consisting of oat protein, rice protein, or a combination thereof. This embodiment of the invention has a PDCAAS equal to 1.0. Furthermore, the reconstituted product has a good taste due to the combination of the plant proteins and the cereals with a low level of beany notes. In this product oat protein has been found to mask pea flavour.

In another preferred embodiment of the invention the beverage or food powder comprises 10-20 wt. % pea protein, 6-12 wt. % other plant-protein, 5-8 wt. % fibers, preferably fibers contained in oat flour, and 0-25 wt. % added sugar.

For example, the powder comprises about 12 wt. % pea protein, and about 8 wt. % oat protein, providing a total of 20 wt. % plant protein in the powder.

Preferably, the plant protein is in the form of isolate or concentrate or flour, the isolate preferably comprising 75-90 wt. % protein, the concentrate preferably comprising 50-70 wt. % protein, and the flour preferably comprising 5-30 wt. %.

In a preferred embodiment of the invention, the powder comprises 10-35 wt. % pea protein isolate. Preferably, the powder comprises 30 to 65 wt. % oat flour, rice flour, or a combination thereof.

When oat and/or rice flour is used they act as bulking agents in the beverage powder and provide fibers to the product. In this preferred embodiment of the invention the food or beverage powder may have a PDCAAS corresponding to milk. For example, the powder has 1.25 times oat flour based on pea isolate content, thus if 15% pea isolate is used, at least 18.75% of oat flour is used and remaining ingredients may be soluble fibers and sugars.

Advantageously, starch in the cereal has been enzymatically treated. As discussed above, high protein and high fiber ingredient mixes can be spray dried. It has been found that by combining pulse proteins, preferably pea, with cereal protein, and enzymatically treating the mixture to break down starch, the obtained reduced viscosity can be sufficient to allow the mixture to be spray dried.

In a preferred embodiment of the beverage or food powder according to the invention, the powder is devoid of animal products.

In a preferred embodiment of the invention, the fibers are fibers, selected from the group consisting of pea, oat, rice, corn fibers, or a combination thereof.

Alternatively, or additionally, a source of fibers selected is from the group consisting of chicory root, sugar beetroot, sugar cane, Jerusalem artichoke or combination thereof, and wherein the fibers are preferably inulin from chicory root, soluble corn fibers, resistant dextrin, polydextrose or a combination thereof. Additionally, the source of fibers may be selected from the group consisting of pea, oat, rice, corn fibers, or a combination thereof.

The composition of the beverage powder in accordance with the present invention may be adjusted so that the final composition has a good taste profile, a good nutritional profile and resembles the appearance and texture of milk. An example of a powder with these properties is shown in FIG. 2.

To improve stability towards flocculation, stabilizing salts may be used. In a preferred embodiment, the stabilizing salts are selected from the group consisting of monopotassium phosphate, dipotassium phosphate, sodium bicarbonate, magnesium carbonate, citrates, or a combination thereof.

It is preferred that the source for fortification is selected from the group consisting of tri-calcium phosphate, calcium carbonate, calcium lactate, calcium chloride, calcium lactogluconate, di-calcium phosphate, tri-calcium citrate, iron, any fortification minerals, or a combination thereof.

If the composition made from the beverage powder of the present invention is used as milk alternative, many consumers may wish to add the composition to coffee, both of which are acidic beverages and—hence—often lead to unwanted protein flocculation. It was found that with the composition of the present invention such unwanted protein flocculation could be avoided. It was furthermore found that if dipotassium phosphate is added to the composition of the present invention, the stability of the liquid food composition of the present invention in hot coffee can even further be increased. Particularly advantageous results were obtained, if the composition of the present invention contained an amount of about 0.3-0.8 g phosphate per 100 ml. Preferably, the powder according to the invention comprises 5-7 wt. % of dipotassium phosphate, monopotassium phosphate and sodium citrate, citric acid, and sodium bicarbonate, or a combination thereof. More preferably, the powder comprising buffer systems of dipotassium phosphate and sodium citrate, or citric acid and sodium bi-carbonate.

Should it be desired to adapt the profile of the composition of the present invention. For this, flavoring agents may be used. Hence, the liquid food composition in accordance with the present invention may further comprise a flavoring agent or a combination of flavoring agents. For example, the flavoring agent may be selected from the group consisting of milk mouthfeel flavor, vanilla flavor, coconut flavor, almond flavor, or combinations thereof.

It is preferred that the vegetable oil is rapeseed oil, high oleic vegetable oil, preferably high oleic sunflower oil. As sunflower oil, any sunflower oil may be used. High quality sunflower oils are however preferred. Sunflower oil can be considered a healthy oil with a high stability. Sunflower oil has a rich content of vitamin E. It also has a good fatty acid profile containing with linoleic acid a polyunsaturated fatty acid and with oleic acid a monounsaturated fatty acid. It is well-known that, for example through a specific cultivation of the sunflowers and through adjusted manufacturing processes, oils with different fatty acid proportions can be manufactured. Oleic acid has been associated with several health benefits such as decreased low-density lipoprotein (LDL) cholesterol, and reduced blood pressure, for example. Hence, some consumers may prefer an oil with a high oleic acid content. High oleic sunflower oil is known and commercially available. High oleic sunflower oil is very high in oleic acid. High oleic sunflower oil is usually defined as having a minimum of 80 percent oleic acid. Consequently, in one embodiment of the liquid food composition of the present invention the sunflower oil may be high oleic sunflower oil.

Sugar may be used in the powder of the present invention to adjust the sweetness of the composition naturally to the sweetness of milk. However, some embodiment of the powder according to the invention may also have no added sugar. If sugar is used, many sugars can be used for this purpose. Preferably the sugar is from sugar cane or beet. For example, the sugar used in the framework of the present invention may be cane sugar. Cane sugar, in particular unprocessed cane sugar may contain small amounts of essential minerals and/or a certain amount of antioxidants.

Whole milk has an energy content of about 60 kcal/100 ml and milk with a 1% fat content slightly above 40 kcal/100 ml. Many consumers prefer products with a lower caloric content, and—hence—it would be desirable, if the reconstituted composition of the present invention had a caloric content of 60 kcal/100 ml or below. It has been found that the present invention achieves this. Hence, the liquid food composition prepared from the powder according to the invention may have an energy content e.g. 55 kcal/100 ml or below with a recommended dosing of about 12.5 grams/100 ml.

Milk is a rich source of nutrition for the needs of a person. As such it provides good amounts of many of the nutrients necessary for the growth and maintenance of the human body. Many consumers would hence prefer a milk alternative to also have a good nutritional profile.

In view of this, the composition of the present invention may be high in protein and/or high in fiber and/or high in calcium.

For example, the food composition of the present invention may comprise per 100 ml about 2.0-2.6 g protein, about 1.3-1.7 g fat, about 2.2-2.8 g carbohydrates, and about 1.8-2.8 g fiber.

The composition of the present invention may further be enriched with vitamins, for example vitamins A, D, B2, and/or B12.

For example, the liquid reconstituted food composition in accordance with the present invention may comprise vitamins selected from the group consisting of vitamin A, vitamin D, vitamin B2 and vitamin B12. In one embodiment of the present invention, the liquid food composition of the present invention may comprise per 100 ml 120-170 mg calcium, 120-170 μg vitamin A, 0.75-1.2 μg vitamin D, 0.21-0.30 mg vitamin B2 and/or 0.38-0.6 μg vitamin B12.

Oats are an excellent source of dietary fiber and are brought associated with many health benefits, such as—for example—a reduction of serum cholesterol levels in the body. Oats contain more soluble fiber than most other grains and are high in protein and healthy fats, and lower in carbohydrates than most other whole grains. Consequently, many breakfasts, such as porridge, for example are based on oats and several breakfast cereals are based on oats as well.

To further improve the nutritional profile of the composition of the present invention oat flour may be added to the composition of the present invention. It was surprisingly found that this was possible without any substantial negative impact on the flavor profile and texture of the composition of the present invention.

Hence, the liquid reconstituted food composition in accordance with the present invention may further comprise oat flour wholemeal. For example, the composition of the present invention may further comprise per 100 ml 3.5-8.0 g oat flour wholemeal.

For example, the liquid reconstituted food composition in accordance with the present invention may comprise per 100 ml 2.5-3.0 g pea protein isolate, about 1.1-1.5 g sunflower oil, 1.8-2.4 g sugar, 3.5-8.0 g oat flour wholemeal, 0.3-0.5 g tribasic calcium phosphate, about 0.5-0.9 g potassium phosphates, 120-170 mg calcium, 120-170 μg vitamin A, 0.75-1.20 μg vitamin D, 0.21-0.30 mg vitamin B2 and/or 0.38-0.60 μg vitamin B12.

The liquid food composition prepared based on the beverage powder in accordance with the present invention may be consumed warm, at ambient temperature or cooled. It may be stable at ambient temperatures, allowing distribution and storage without additional cooling facilities.

It may be used as a drink. For example, the liquid food composition obtained by reconstitution of the powder in accordance with the present invention may be used as a plant-based milk alternative. One advantage of the composition of the present invention is that it is stable in some acidic environments. Coffee, for example may have a pH about 5. The reconstituted liquid food composition obtained with the powder in accordance with the present invention may be stable in acidic food compositions, such as coffee. “Stable” is to be understood in this case as showing no visible protein coagulation during at least 10 minutes. Hence, the liquid food composition in accordance with the present invention may be used as coffee whitener.

In a preferred embodiment, the reconstituted wherein the beverage powder has a pH in the range of 6.6 to 8.5 when reconstituted in 180 ml of water per 20-30 grams of powder. This provide a good stability of the final product in particular when it is added to a liquid food composition having a pH in the range of 5.0 to 7.0.

The invention also relates to a method of making a beverage powder comprising the steps of
providing a mixture of pea protein, other plant protein, enzyme, and oat and/or rice flour with 30-40% total solids and preferably having a pH of between 6 and 9, hydrolysing the mixture for 10 min to 1 hour,
optionally dispersing vegetable oil or fat in the mixture, preferably to a 40-48% total solids, and
spray drying the mixture to obtain a beverage powder.

Alternatively, the invention relates to a method of making a beverage powder comprising the steps of
adding enzyme in water,
adding the oat and/or rice flour at a 15-30% total solids,
hydrolyzing the oat and/or rice for 10 min to 1 hour,
adding the pea protein and other plant protein to a 30-40% total solids to water to form a plant protein mixture and preferably having a pH of between 6 and 9,
optionally dispersing vegetable oil or fat in the plant protein mixture, preferably to a total solids of 40-48%, and
spray drying the mixture to obtain a beverage powder.

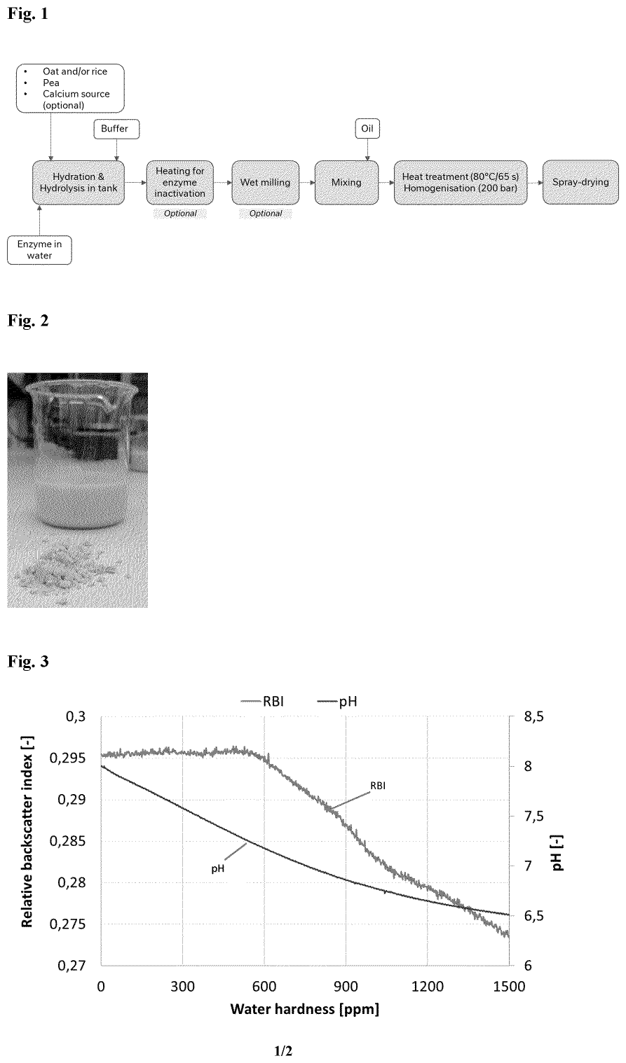

FIG. 1 illustrates schematically an embodiment of the method according to the invention.

In FIG. 1 the oat and/or rice and pea proteins and the optional calcium source is hydrated in the hydrolysis tank. Enzymes are added to water which is the added to the tank. An optional heating may take place to inactivate the enzymes. Vegetable oil or fat is then added during mixing. A heat treatment and homogenization then take place followed by spray drying. To reduce particle size, a milling step may be part of the method according to the invention. In a preferred embodiment of the invention the homogenization is high pressure homogenization.

The enzymes are preferably added to the water in an amount of 0.1-0.2 wt. % on oat and rice basis.

In the present context enzymes are starch degrading and optionally fiber-degrading enzymes e.g. α-amylase, amyloglucosidase, α-amylase with side β-glucanase activity.

Optionally adding sugar, polyol, or one or more polysaccharides or mixtures thereof to the plant protein mixture.

When vegetable oil or fat is added in the method according to the invention it is preferred that the ingredient mix is homogenized at high pressure (>100 bar). It has been found that a dry mix of ingredients comprising a substantial amount of protein will not dissolve in liquid. At high total solids the mix cannot be pumped and sprayed. At the same time the pH of the ingredient mix must be above 6 or protein will flocculate, and the protein structure will change.

In one embodiment of the beverage powder according to the invention dried ingredients are added to the final spray dried powder.

In one embodiment of the method according to the invention the method comprises a step of optionally adding sugar, polyol, or one or more polysaccharides or mixtures thereof to the plant protein mixture;

The protein is acting as an emulsifier and there is no need to add emulsifiers to the mixture

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

The beverage powder according to the invention is made with a method as shown in FIG. 1. In the following examples such a method is applied to the recipes:

| | % wt. (dry basis) |
|---|---|
| Pea-oat | |
| Oat flour | 63.25 |
| Pea protein isolate | 15.00 |
| Sunflower oil | 16.00 |
| Calcium carbonate | 3.75 |
| Di-potassium phosphate | 2.00 |
| Enzyme α-amylase (0.1-0.2% on oat) | 0.06325-0.1265 |
| Pea-oat-rice | |
| Oat flour | 35.00 |
| Rice flour | 28.50 |
| Pea protein isolate | 15.00 |
| Sunflower oil | 16.00 |
| Calcium carbonate | 3.75 |
| Di-potassium phosphate (DPP) | 2.00 |
| Enzyme α-amylase (0.1-0.2% on oat and rice) | 0.06325-0.1265 |

### Reconstitution:

To prepare a glass of milk alternative 25 g of powder are mixed with 180 mL of water (ambient 20° C. or warm temperature 40° C.).

The composition was tested by experts, and it was found that the powder dissolves easily and rapidly, resulting in a beverage with a pleasant taste and texture, no lumps and no sedimentation.

To prepare a white coffee cup: 1 g pure soluble coffee+3 g beverage powder according to the invention (as shown in Table 1)+2.5 g sugar in 100 mL water at 80° C. the powder dissolves easily and rapidly, resulting in a beverage with a pleasant taste and texture, no lumps, no sedimentation, no flocculation.

FIG. 3 shows a hard water stability of the reconstituted beverage. No flocculation below 550 ppm,

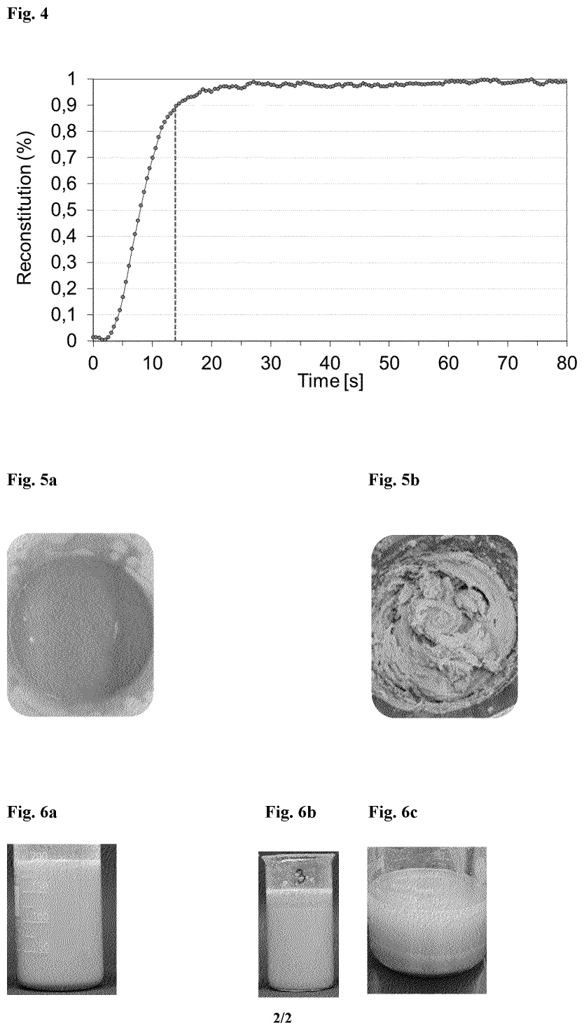

FIG. 4 shows instant reconstitution properties of the beverage powder according to the invention. An instant reconstitution is obtained with t90<15 s,

FIGS. 5a and 5b shows the plant-based mixture before spray drying with and without starch-degrading enzymatic treatment of the plant-based mixture. The plant-based mixture in FIG. 5b cannot be pumped or spray dried at 48% TS.

FIG. 6a shows a stable product obtained with the beverage or food powder according to the invention. The product has dispersion stability, no sedimentation, and no flocculation. FIGS. 6b and 6c not according to the claimed invention and have flocculation/phase separation.

1. Spray dried beverage or food powder comprising
10-35 wt. % pea protein,
2-15 wt. % other plant protein,
3-8 wt. % fibers, selected from the group consisting of cereal, pseudo cereals seeds er and a combination thereof, and
0-30 wt. % vegetable oil or fat.

2. Beverage or food powder according to claim 1, wherein the other plant protein is selected from the group consisting of oat protein, rice protein, and a combination thereof.

3. Beverage or food powder according to claim 1, wherein the powder comprises
10-20 wt. % pea protein,
6-12 wt. % other plant-protein,
5-8 wt. % fibers, and
0-25 wt. % added sugar.

4. Beverage or food powder according to claim 1, wherein the plant protein is in the form of isolate or concentrate or flour.

5. Beverage powder or food according to claim 1, comprising 10-35 wt. % pea protein isolate.

6. Beverage powder or food according to claim 1, comprising 30 to 65 wt. % oat flour, rice flour, or a combination thereof.

7. Beverage or food powder according to claim 1, wherein starch in the cereal has been enzymatically treated.

8. Beverage or food powder according to claim 1, having no added sugar.

9. Beverage or food powder according to claim 1, devoid of animal products.

10. Beverage or food powder according to claim 1, wherein source for fortification is selected from the group consisting of tri-calcium phosphate, calcium carbonate, calcium lactate, calcium chloride, calcium lactogluconate, di-calcium phosphate, tri-calcium citrate, iron, any fortification minerals, and a combination thereof.

11. Beverage or food powder according to claim 1, wherein the beverage powder comprises additional fibers from a source of fibers selected from the group consisting of chicory root, sugar beetroot, sugar cane, Jerusalem artichoke, soluble corn fibers, resistant dextrin, polydextrose. and combinations thereof.

12. Beverage or food powder according to claim 1, wherein the fibers are fibers selected from the group consisting of pea, oat, rice, corn fibers, and a combination thereof.

13. Beverage or food powder according to claim 1, wherein the stabilizing salts are selected from the group consisting of monopotassium phosphate, dipotassium phosphate, sodium bicarbonate, magnesium carbonate, citrates, and a combination thereof.

14. Beverage or food powder according to claim 1, wherein the vegetable oil is selected from the group consisting of rapeseed oil and high oleic vegetable oil, preferably high oleic sunflower oil.

15. Beverage or food powder according to claim 1, wherein the beverage powder when reconstituted in liquid is a plant-based milk alternative.

16. A method of making a beverage or food powder comprising the steps of
providing a plant protein mixture of pea protein, other plant protein, enzyme, and cereals and/or pseudo cereals with 30-40% total solids,
hydrolyzing the mixture for 10 min to 1 hour,
heat treating and homogenizing the mixture and
spray drying the mixture to obtain a beverage powder.

17. A method of making a beverage or food powder comprising the steps of
adding enzyme in water,
adding cereals and/or pseudo cereals at a 15-30% total solids,
hydrolyzing the cereals and/or pseudo cereals for 10 min to 1 hour
adding the pea protein and other plant protein to a 30-40% total solids to water to form a plant protein mixture,
heat treating and homogenizing the plant protein mixture and
spray drying the mixture to obtain a beverage powder.
